(19) United States
(12) Patent Application Publication
(10) Pub. No.: US 2002/0194118 A1
(43) Pub. Date: Dec. 19, 2002

(54) Method for processing an asset-secured credit application

(76) Inventor: John Z. Nassar, Mississauga (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 09/881,034

(22) Filed: Jun. 15, 2001

(51) Int. Cl. G06F 17/60

(52) U.S. Cl. 705/38; 705/39

(57) ABSTRACT

A method is described for processing an asset-secured credit application. This method separates the process of assessing the potential borrower from the process of arranging asset-based terms and fully identifying the asset. As a result of this separation, applications for credit can be processed more easily over new communications technologies, such as wireless communications.

### BACKGROUND

Traditionally, salespersons selling relatively expensive items, such as cars, refrigerators, appliances, heating systems, air conditioning systems, or home renovations, have offered financing in the form of a loan (or “credit”) secured by the asset being financed. In some cases, the potential customers complete an application for credit at locations such as car dealerships, hardware stores, or appliance departments in department stores. In other cases the application for credit is completed at the customer's home in the case of an individual, or at the customer's place of business in the case of a business entity.

The decision maker who has authority to approve requests for credit is typically in a second location, which may be in a different city or at a distance from the place where the credit application is being completed. The contents of the application must therefore be communicated from the salesperson to the decision maker, whether by regular mail, intra-company mail, courier or, in more recent times, facsimile. The credit application typically contains a large amount of information, such as multiple details to identify the applicant, the applicant's present assets and liabilities, and an identification of the asset (or product) to be used as security for the purchase. With this information, the decision maker approves or declines an application, perhaps with conditions, and communicates the decision to the salesperson. In some cases, the decision maker sends a completed contract, which extends credit and secures the asset, to the salesperson who then causes the customer to sign it. In other cases the salesperson completes a contract based upon information provided by the decision maker.

Since the approval and preparation of the contract may take some time, the salesperson and customer may need to meet at a later time to learn whether the application for credit was declined or approved, make further negotiations, or sign a contract.

With the recent widespread adoption of computers and the Internet, a different process is possible. The salesperson may enter the application information into a computer connected by wire to the Internet, and the information is sent over the Internet to the decision maker. Typically, this information is the same sort of information used in the older methods described above. The use of the Internet speeds communication with the decision maker as compared to the methods described above. A customer may therefore receive an answer to his credit request almost immediately, depending in part upon the speed with which the decision maker can process and approve or decline credit requests.

However, the use of computers communicating by wire to the Internet limits the locations where credit applications may be taken to locations where communication by wire is feasible. In particular, the use of computers communicating by wire to the Internet makes it difficult to complete and process applications for credit at the customer's home or place of business.

These limitations can be addressed through the use of wireless communications. However, portable wireless communication devices generally have small screens and small or inconvenient data entry means. The small size of the screen and of the data entry means can lead to frustration on the part of the customer and salesperson entering application information, and can also lead to errors in the entry of information. Incorrect information transmitted to the decision maker can lead to errors in the issuance, or denial of, credit. Furthermore, the long time taken to enter large amounts of information can discourage potential customers, and discourage the adoption and use of wireless communications by sales forces. In some cases, this additional time for data entry may discourage the transformation of a sales force from a relatively immobile sales force, centred on particular locations, to a fully mobile sales force.

A better method of applying for and approving asset-secured credit requests is therefore desirable.

### INTRODUCTION

The method in this application simplifies the asset-secured credit approval process by separating the process of assessing the potential borrower from the process of arranging asset-based terms and fully identifying the asset in case of future problems. As a result of this separation, applications for credit can be processed more easily than previously over new communications technologies, such as wireless or Internet communications.

According to an aspect of the present invention, there is provided a method for approving asset secured credit requests comprising the steps of taking applicant identification information from an applicant in a first location, sending at least some of the applicant identification information to a decision maker in a second location, and receiving a decision from the decision maker, wherein the step of sending at least some of the applicant identification information to a decision maker in a second location comprises entering the at least some of the applicant identification information into a wireless communications device, transmitting the applicant identification information to the decision maker via a signal transmitted by the wireless communication device, and wherein the step of receiving a decision from the decision maker further comprises receiving a decision from the decision maker via a signal received by the wireless communications device. In accordance with an additional feature of this aspect of the invention, the step of transmitting the applicant identification information comprises transmitting only the applicant identification information.

In accordance with yet another additional feature of this aspect of the invention, the applicant identification information is the minimum data required to identify a potential borrower. In accordance with still another additional feature of this aspect of the invention, the method further comprises a step of preparing contractual documents using more information than the information transmitted to the decision maker to prepare the contractual documents. This step may further additionally feature the steps of taking asset information from the applicant, taking payment and banking information from the applicant, entering the asset information and the payment and banking information into the wireless communications device, and printing the contractual documents using the wireless communications device at the first location. In accordance with still another additional feature of this aspect of the invention, the step of preparing contractual documents is performed by the decision maker.

In an additional feature of this aspect of the invention, the transmitting involves at least in part transmission over a packetized data network. In yet another additional feature of this aspect of the invention, the wireless communication device is a portable wireless communication device. In still another additional feature of this aspect of the invention, the wireless communications device is a hand-held computing device.

In accordance with another feature of this aspect of the invention, the decision maker is an automated decision maker.

According to another aspect of the present invention, there is provided a method for approving asset secured credit requests comprising the steps of taking applicant identification and asset information from an applicant for credit in a first location, sending at least some of the applicant identification information and at least some of the asset information to a decision maker in a second location, and receiving a decision from a decision maker, wherein the step of sending at least some of the applicant identification information to a decision maker in a second location comprises entering the at least some of the applicant identification information and the at least some of the asset information into a wireless communications device, transmitting the at least some of the applicant identification information and the at least some of the asset information to the decision maker via a signal transmitted by the wireless communication device, and wherein the step of receiving a decision from the decision maker further comprises receiving a decision from the decision maker via a signal received by the wireless communications device. In an additional feature of this aspect of the present invention, the applicant identification information is the minimum data required to identify a potential borrower.

In another additional feature of this aspect of the present application, the method further comprises a step of preparing contractual documents using more information than the information transmitted to the decision maker to prepare the contractual documents. In yet another additional feature of this aspect of the present invention, the step of preparing contractual documents using more information than the information transmitted to the decision maker to prepare the contractual documents comprises the steps of taking payment and banking information at the first location, entering the payment and banking information into the wireless communications device, and printing contractual documents using the wireless communications device at the first location. In still another additional feature of this aspect of the present invention, the step of preparing contractual documents using more information than the information transmitted to the decision maker to prepare the contractual documents is performed by the decision maker.

In an additional feature of this aspect of the present invention, transmitting involves at least in part transmission over a packetized data network. In another additional feature of this aspect of the present invention, the wireless communication device is a portable wireless communication device. In yet another additional feature of this aspect of the present invention, the wireless communications device is a hand-held computing device.

In an additional feature of this aspect of the present invention, the decision maker is an automated decision maker.

In another aspect of the present invention, there is provided a method for approving asset secured credit requests over a wireless communication device, comprising the steps of entering applicant identification information into the wireless communications device, transmitting only the applicant identification information to a decision maker via a signal transmitted by the wireless communication device, and receiving a decision on how much credit to offer from the decision maker.

In an additional feature of this aspect of the present invention, the method further comprises the step of preparing contractual documents using more information than the information transmitted to the decision maker to prepare the contractual documents. In another feature of this aspect of the present invention, the applicant identification information is the minimum data required to identify a potential borrower, and in yet another additional feature, the method further comprises the step of preparing contractual documents using more information than the information transmitted to the decision maker to prepare the contractual documents.

In an additional feature of this aspect of the present invention, the step of preparing contractual documents using more information than the information transmitted to the decision maker to prepare the contractual documents comprises the steps of taking asset information from the applicant, taking payment and banking information from the applicant, entering the asset information and the payment and banking information into the wireless communications device, and printing the contractual documents using the wireless communications device at the first location.

In yet another additional feature of this aspect of the present invention, transmitting involves at least in part transmission over a packetized data network. In another additional feature of this aspect of the present invention, the wireless communication device is a portable wireless communication device. In still another additional feature of this aspect of the present invention, the wireless communications device is a hand-held computing device. In an additional feature of this aspect of the present invention, the step of preparing contractual documents is performed by the decision maker. In still another additional feature of this aspect of the present invention, the decision maker is an automated decision maker.

In another aspect of the present invention, there is provided a method for approving asset secured credit requests over a wireless communication device, comprising the steps of entering applicant identification information and asset information into the wireless communications device, transmitting the applicant identification information and asset information to a decision maker via a signal, and receiving a decision on how much credit to offer from the decision maker. In an additional feature of this aspect of the present invention, the applicant identification information is the minimum data required to identify a potential borrower.

In another additional feature of this aspect of the present invention, the method further comprises the step of preparing contractual documents in accordance with such decision, while using more information than the information which had been transmitted to the decision maker. In yet another additional feature of this aspect of the present invention, the step of preparing contractual documents comprises the steps of taking payment and banking information, entering the payment and banking information into the wireless communications device, and printing contractual documents using the wireless communications device.

In yet another additional feature of this aspect of the present invention, transmitting involves at least in part transmission over a packetized data network. In still another additional feature of this aspect of the present invention, the wireless communication device is a portable wireless communication device, and in another additional feature of this aspect of the present invention the wireless communications device is a hand-held computing device. In another additional feature of this aspect of the present invention, the decision maker is an automated decision maker. In yet another additional feature of this aspect of the present invention, the step of preparing contractual documents is performed by the decision maker.

In another aspect of the present invention, there is provided a method for securing approval of a credit transaction, in which information is collected at a first location and is submitted to a second location for transaction approval and preparation of contract documentation, the improvement which comprises: determining the information necessary to be collected for transmission to the second location; segregating such information into a first set of information and a second set of information, said first set comprising information necessary for credit approval and said second set comprising the remaining information; collecting at least the first set of information at said first location; transmitting said first set of information to the second location via wireless communication; awaiting the receipt of a decision on the granting of credit sent from said second location; and if a decision favourable to the granting of credit is received from said second location, then transmitting the second set of information to said second location.

In another additional feature of this aspect of the present invention, at least a portion of said second set of information is not collected unless and until a decision favourable to the granting of credit is received. In still another additional feature of this aspect of the present invention, the second set of information is removed from the first location to a third location in a stored form prior to transmission, and is transmitted to the second location from the third location. In yet another additional feature of this aspect of the present invention, the second set of information is removed from the first location to a third location in a stored form prior to transmission, and is transmitted to the second location from the third location. In yet another additional feature of this aspect of the present invention, collecting and transmitting is performed using a wireless communications device. In another additional feature of this aspect of the present invention, the wireless communications device is a portable wireless communications device. In still another additional feature of this aspect of the present invention, transmitting involves at least in part transmission over a packetized data network.

In another aspect of the present invention, there is provided a method for securing approval of a credit transaction, in which information is collected at a first location and is submitted to a second location for transaction approval, the improvement which comprises: determining the information necessary to be collected for the preparation of contractual documents; segregating such information into a first set of information and a second set of information, said first set comprising information necessary for credit approval and said second set comprising the remaining information; collecting at least the first set of information at said first location; transmitting said first set of information to the second location via wireless communication; and awaiting the receipt of a decision on the granting of credit sent from said second location.

In an additional feature of this aspect of the present invention, the method further comprises the step of: if a decision favourable to the granting of credit is received from said second location, then using the first set of information and the second set of information to prepare contractual documents. In another additional feature of this aspect of the present invention, the second set of information is removed from the first location to a third location in a stored form prior to preparation of the contractual documents.

In another additional feature of this aspect of the present invention, at least a portion of the second set of information is not collected unless and until a decision favourable to the granting of credit is received. In yet another additional feature of this aspect of the present invention, the method comprises an additional step of if a decision favourable to the granting of credit is received from said second location, then using the first set of information and the second set of information to prepare contractual documents. In still another additional feature of this aspect of the present invention, the second set of information is removed from the first location to a third location in a stored form prior to preparation of the contractual documents.

In another additional feature of this aspect of the present invention, collecting and transmitting is performed using a wireless communications device. In yet another additional feature of this aspect of the present invention, the wireless communications device is a portable wireless communications device. In still another additional feature of this aspect of the present invention, transmitting involves at least in part transmission over a packetized data network.

### DESCRIPTION OF THE FIGURES

FIG. 1 is a schematic illustration of a known asset-secured credit application processing method;

FIG. 2 is a schematic illustration representing a second known asset-secured credit application processing method;

FIG. 3A is a schematic illustration representing an asset-secured credit application processing method useable with one embodiment of the invention.

FIG. 3B is a schematic illustration representing an asset-secured credit application processing method useable with a second embodiment of the invention.

FIG. 4 is block diagram of the steps for processing an asset-secured credit application according to the embodiments of FIGS. 3A or 3B.

FIG. 5 is block diagram of a second series of steps for processing an asset-secured credit application according to the embodiments of FIGS. 3A or 3B.

FIG. 6 is a block diagram of a third series of steps, for securing approval of an asset-secured credit transaction.

FIG. 7 is a block diagram of a fourth series of steps, for securing approval of an asset-secured credit transaction.

### DETAILED DESCRIPTION

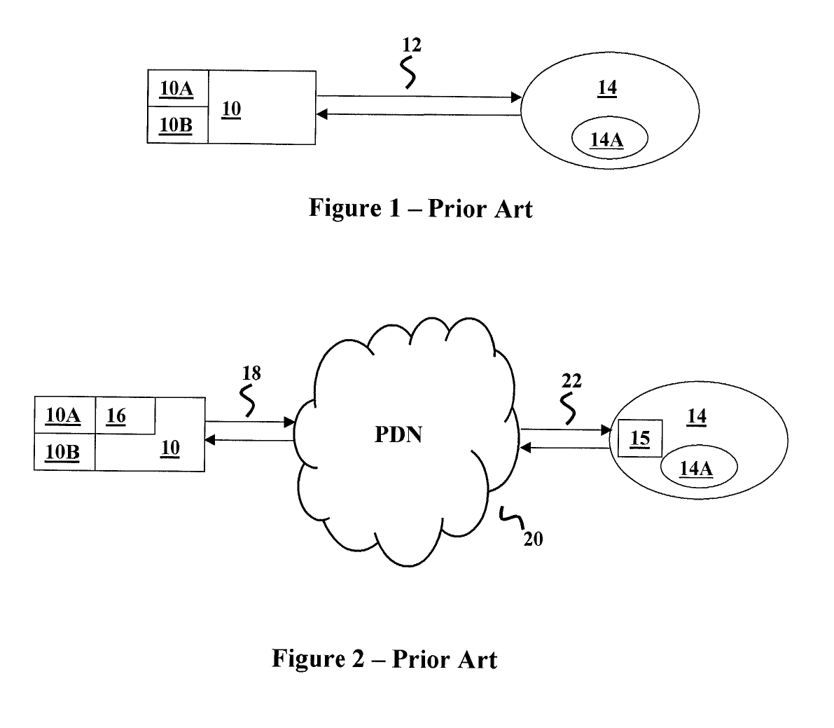

A known method of processing and granting asset-secured credit requests is illustrated in FIG. 1. In FIG. 1, a written credit application is filled out at location 10. Present are a salesperson 10A and a customer 10B. Location 10 is a location where sales are made of relatively expensive products (also referred to in this description as “assets”) such as cars, refrigerators, appliances, heating systems, air conditioning systems, or home renovations. Location 10 can be, for example a car dealership, hardware store, an appliance department in a department store, or a similar sales location. It can also be the customer 10B's own home or business premises, where the product involved is one which can conveniently be sold at the customer 10B's own premises. The customer 10B can be either an individual or a business entity.

As part of the sales process, the customer 10B and salesperson 10A at location 10 might wish to arrange financing for the purchase of the products by an extension of credit secured by the product or asset to be purchased. However, the decision maker 14A who has authority to approve requests for credit is typically in a second location 14, which may be in a different city or distant from location 10.

To obtain approval for the credit financing, the customer at location 10, often assisted by the salesperson 10A at location 10, will fill out an application for credit. This application is then conveyed to the decision maker 14A by some method of communication 12, which can be for example regular mail, intra-company mail, courier or facsimile. The application filled out at location 10 contains a large amount of information, such as an identification of the purchaser and his present assets and liabilities and an identification of the asset (or product) to be used as security for the purchase. With this information, the decision maker 14A will approve or decline an application, perhaps with conditions, and will then communicate his decision to location 10. In some cases, the decision maker 14A may send completed contractual documents to location 10 extending credit and securing the asset for the customer 10B to sign. Since the approval and preparation of the contract may take some time, the customer 10B may leave location 10 and return at a later time to learn whether the decision maker 14A has approved the application for credit.

The information typically collected on an application for asset-secured credit serves a number of functions. Two functions are to identify the borrower clearly, and to identify the asset securing the loan clearly. However, much more information is typically gathered, in large part to be used if the borrower is unable to meet his credit obligations. As a result, the typical credit application will include information that the lending company can use to trace the borrower, and to trace assets of the borrower, such as credit card numbers, details on bank accounts, and the employment situation of the borrower. Similarly, details are often collected to aid in the tracing and identification of the asset in case the borrower attempts in the future to mask the identity of the asset.

With the recent widespread adoption of computers and the Internet, a different process is possible, as illustrated in FIG. 2. In FIG. 2, the application information is entered into a computer 16 at location 10 by salesperson 10A. The application information is transmitted through communication lines 18 to a packetized data network (“PDN”) 20, such as the Internet. A computer 15 in the location of decision maker 14A is attached through communication lines 22 to PDN 20, and receives the transmitted information. Lines 18 and 22 can be dedicated lines or can be established on an as-needed basis, e.g., through a switched connection using the public telephone network or the PDN 20 itself

Typically, the same sort of information that is entered into an application for credit in the situation described in relation to FIG. 1 is entered into the computer 16 in FIG. 2. The use of a PDN for communication generally speeds communication between the salesperson 10A and the decision maker 14A as compared to the methods illustrated in FIG. 1, so that the customer 10B can receive an answer to the credit request almost immediately. However, computers 16 suitable for connecting to a PDN 20 through lines 18 are generally not portable, and while suitable for use in a central sales location, are unsuitable for applications to be filled out at the premises of the customer, or in any other situation where the applications are to be filled out by a roving salesperson.

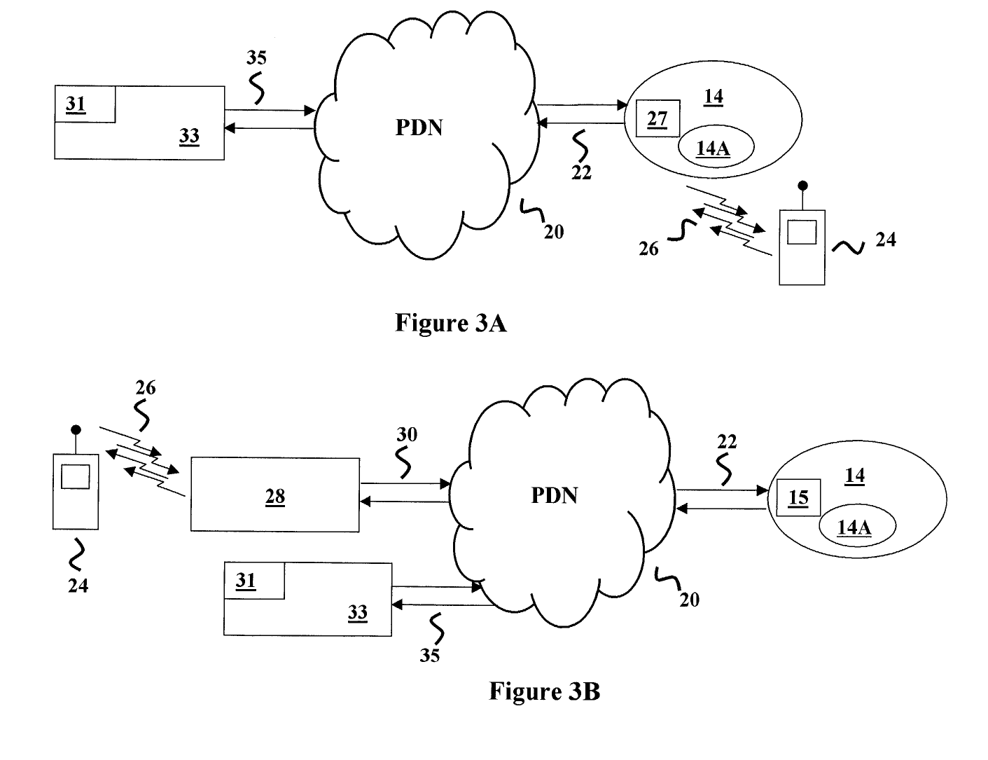

According to the invention, data is entered and transmitted as illustrated in FIGS. 3A and 3B. In FIG. 3A, information related to a loan application can be entered by a salesperson into portable wireless communication device 24. Portable wireless communication device 24 is a device that allows storage of textual information related to a credit application (such as applicant name, SIN, amount of loan, etc.) and can transmit selected portions of such textual information wirelessly. An example would be a personal digital assistant, such as a Palm Pilot (T.M.), or a RIM Blackberry (T.M.). The information is transmitted though a signal (generally a radio signal, but more broadly including electromagnetic or infra-red signals) 26 to a wireless device 27 at the location 14 of decision maker 14A. Decision maker 14A can then transmit the decision back to wireless device 24.

A variation of this is illustrated in FIG. 3B, where portable wireless communication device 24 communicates through signals 26 to a receiver 28, which can be a receiver/transmitter dedicated to receiving wireless signals from a plurality of wireless devices 24 by means of signals 26, and transmitting signals to such wireless devices. Receiver 28 can be an integral part of a computer. Receiver 28 receives application information entered onto portable wireless communication device 24 by means of signal 26a and transmits the information through lines 30, PDN 20 and lines 22 to computer 15 of decision maker 14A. Decision maker 14A then transmits the decision back to portable wireless communication device 24 via computer 15, lines 22, PDN 20, lines 30, receiver/transmitter 28 and signals 26.

If further communication of information between the salesperson and decision maker 14A is desired in either FIG. 3A or FIG. 3B, the salesperson can return to their sales office 33 and transmit information to decision maker 14 through computer 31 via lines 18 and PDN 20.

While FIG. 3B has a PDN 20 to facilitate communication between receiver 28 and decision maker 14, any method of communication may be used between receiver 28 and decision maker 14 that will facilitate fast communication—such as a dedicated wired data network—and still be within the scope and spirit of the invention.

The use of a portable wireless communication device 24 allows application information to be taken and entered at any location where the wireless device can communicate with a receiver transmitter or with a wireless device of the decision maker. In many cases, this permits the taking of information and entry of data at the premises of customers, and allows data to be communicated quickly between a salesperson bearing portable wireless communication device 24 and decision maker 14A. Depending upon the speed with which decision maker 14A deals with a credit application, and the speed of communication between portable wireless communication device 24 and decision maker 14A, a decision on the extension of credit can often be transmitted back to portable wireless communication device 24 while the salesperson waits with the customer.

There is, however, a limitation in equipment capability which has heretofore made the use of a portable wireless communication device impractical for credit approvals of asset-secured loans. Portable wireless communication devices generally have small screens. This can be illustrated, for example, by a popular line of wireless devices distributed by Research in Motion (RIM (T.M.)) of Waterloo, Ontario. The RIM 850 (T.M.) and RIM950 (T.M.) wireless handheld products have screens that display 6 or 8 lines of text, while the RIM 857 (T.M.) and 957 (T.M.) wireless handheld products have screens that display 16 or 20 lines of text. While other wireless handheld communications devices may have screens of slightly different sizes, these sizes are typical for the industry.

Furthermore, portable wireless communication devices generally have small keyboards or other means for entering information. In some, the keyboard is so small that a stylus must be used for data entry. In others, a limited character set is available, so that the entry of even some common characters requires simultaneous activation of several keys.

The small size of screen and means of entering information can lead to frustration on the part of the customer and salesperson entering application information, and can also lead to errors in the entry of information. Incorrect information transmitted to the decision maker 14A can lead to errors in the issuance, or denial of, credit. Furthermore, the requirement of entering large amounts of information can discourage potential customers, and can discourage the adoption and use of wireless communications by sales forces. In some cases, the time loss involved can discourage the transformation of a sales force from a relatively immobile sales force, centred on particular locations, to a fully mobile sales force.

In addition, in either the wireless or wired communication situation, frustration can result from the customer and salesperson filling out large amounts of information only to have the application subsequently declined.

To solve this problem, the method of applying for asset-secured credit is changed by the inventive method to minimize the entry of information before the decision maker 14A reaches a credit-granting decision. This is done by separating the process of assessing the potential borrower from the process of arranging asset-based terms and fully identifying the borrower and asset in case of future problems. Indeed, the inputting and transmitting of information related to the asset used to secure the loan may be postponed to a later time or avoided altogether if the loan is declined. Instead, only the applicant identification information, and in one embodiment only the minimum information needed to identify the borrower is inputted and transmitted to the decision maker. This information allows the decision maker to decide whether it is willing to grant credit, and a maximum amount. To make this determination, a variety of assumptions about the asset that will secure the loan may be made as pre-determined between the sales force and decision maker. This credit decision and maximum amount is transmitted back to the sales person, who may then conclude a contract with the customer. In cases where the application is declined by the decision maker 14A, the salesperson and customer are saved the time and effort of entering additional data.

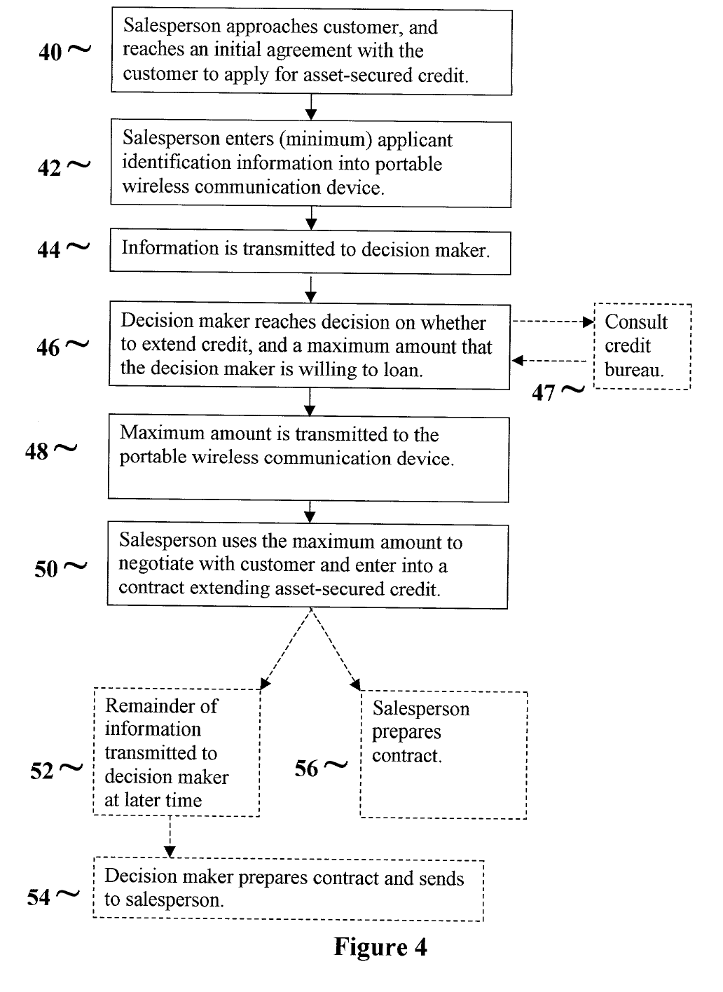

This method is illustrated in FIG. 4, which sets out the steps of the method. In step 40, the salesperson approaches the customer, and reaches an initial agreement with the customer to apply for asset-secured credit. In step 42, the salesperson enters information to identify the potential borrower into a portable wireless communication device.

In one embodiment, the salesperson inputs only the minimum information needed to identify the potential borrower. This minimum information could be the potential borrower's name and an identifier, such as a credit card number, Social Security number (for U.S. customers) or Social Insurance Number (for Canadian customers), or birthdate or address. If desired, two identifiers can be provided, to provide a cross-check on identity. The content of the minimum information needed to identify the potential borrower may vary by legal jurisdiction, or vary depending on the internal organization of the decision maker or the credit information agencies used by the decision maker.

Next, in step 44, the identification information is transmitted to the decision maker. In step 46, the decision maker reaches a decision on whether to grant credit to the potential borrower. This will include a maximum amount that the decision maker is willing to loan to the potential borrower.

The actual mechanics of step 46 may vary from implementation to implementation. The speed of the processing of the information will vary from decision maker to decision maker, depending in part on how automated and thorough the decision maker is. In a preferred embodiment, the decision maker is an automated program which will reach a decision swiftly and without human intervention. The decision maker may also consult a credit bureau (shown in FIG. 4 as a dotted step 47), and the speed of the response of the credit bureau to inquiries may also affect the speed of step 46.

The mechanics of step 46 may also vary depending upon the assumptions made by the decision maker, presumably in agreement with the sales agents, regarding the asset that will act as security to the loan. In one embodiment, the decision maker need not make any assumptions about the value of the asset that will be used to secure the loan (beyond assuming that the loan will be secured by an asset of some minimal value). In an alternate embodiment, the decision maker can make an assumption about the value of the asset securing the loan. For example, if the salespeople in a particular case only sell products in a limited range of value, the decision maker can assume that offers of credit arranged through these salespeople will be secured with an asset in that value range. Similarly, assumptions can be made by the decision maker about the liquidity, removability and seizability of the asset securing the loan. Assumptions can also be made about the conditions of the loan, such as assuming the agreement will include a 25% down payment. Typically, the decision, the identification information of the potential borrower, and the maximum amount that the decision maker is willing to lend will be entered into a database at the decision maker's location for storage and future consultation.

In step 48, the decision to extend credit, and the maximum amount of credit the decision maker is willing to extend to this potential customer, is transmitted back to the salesperson. To do this, decision maker need only transmit a maximum amount that decision maker is willing to loan to the potential customer, with an amount of zero indicating a rejection. It is preferrable to include in this transmission an approval number associated with this particular approval, to be used by the decision maker and salesperson in identifying and confirming this particular approval.

The information which the salesperson receives from the decision maker is then used in step 50 by the salesperson to conclude a contract with the potential customer extending credit secured by the asset to be purchased.

In a preferred embodiment, the communication in step 48 is made to the salesperson via the wireless communications device used in step 42, and steps 44 and 46 are fast enough that the salesperson will be able to give the potential customer an answer while the potential customer waits.

In some cases, the decision maker may be unable to reach a decision on granting credit while the customer waits. In such a case, the decision maker may send a response of “pending” in step 48, and the salesperson may inform the customer that the decision maker requires more time to make a decision on whether to extend credit. Alternatively, decision maker 14 may send a signal to wireless communication device 24 requesting that additional information to identify the potential customer be inputted into the wireless communication device 24 and transmitted to the decision maker for further consideration.

In some cases, the amount of credit that the decision maker 14 is willing to advance will be insufficient to complete the purchase. In such a situation, it will be up to the sales person to negotiate with the potential customer to see if an agreement can be reached for the customer to provide more money up-front or in some other way complete the purchase.

Generally, step 52 will involve the salesperson obtaining and recording, in some cases by further entries into his portable wireless communications device, further information necessary to complete the transaction, such as more of the potential customer's identification information, details of the asset securing the loan, payment details, and banking details.

Step 50 can optionally be followed by the salesperson preparing a contract on the spot with the customer when the salesperson receives the credit decision, as shown by dotted box 56. The salesperson will print out a suitable contract for signature by the customer. In a preferred embodiment, the contract will be printed out using the wireless communication device. The contract, or an application form prepared as part of the contracting process, will contain information which is additional to the information which had been sent to the decision maker. This will include information which would assist in recovery of the asset in the case of default (such as the serial number of the asset and the like) and the value of the asset. It will also include information obtained from the customer that would assist in tracing the customer in the case of default or recovering the asset or its value. This information can include, for example, place of work, other assets, or the like.

Alternatively, the salesperson can input further information regarding the borrower and asset (such as the information listed above), and later transfer the further information to decision maker 14A according to dotted box 52. (Referring to FIG. 3b, the salesperson can return to their sales office 33 and transmit information to decision maker 14 through computer 31 via lines 18). The decision maker 14A can then prepare the contract and send it to the customer via the salesperson as shown by dotted box 54 or directly to the customer (not shown) for signature. Alternately, the contract can be prepared by any other suitable means, for example, by having the salesperson fill out a pre-printed form contract.

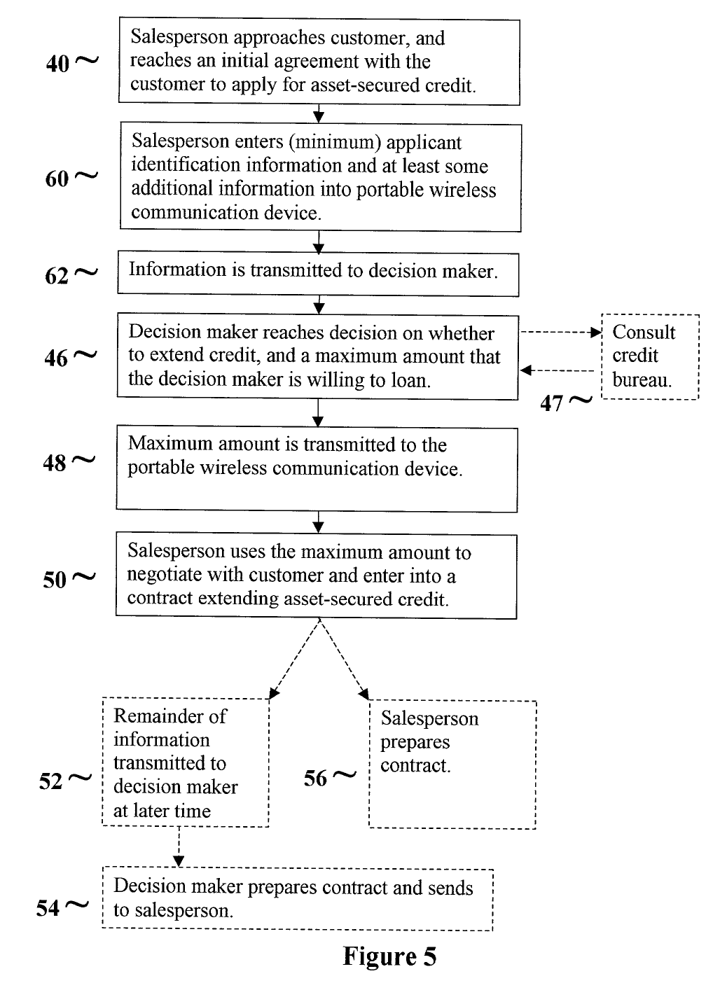

A second method according to the invention is illustrated in FIG. 5, which is a modified version of FIG. 4 and wherein like steps have received like numbers. In step 60, instead of entering only applicant identification information into the portable wireless communication device, the salesperson enters applicant identification information and some additional information, such as limited asset information or limited payment or banking information, into the portable wireless communication device. This information is transmitted to the decision maker in step 62, who reaches a decision in step 46. The rest of the method proceeds as described in relation to FIG. 4.

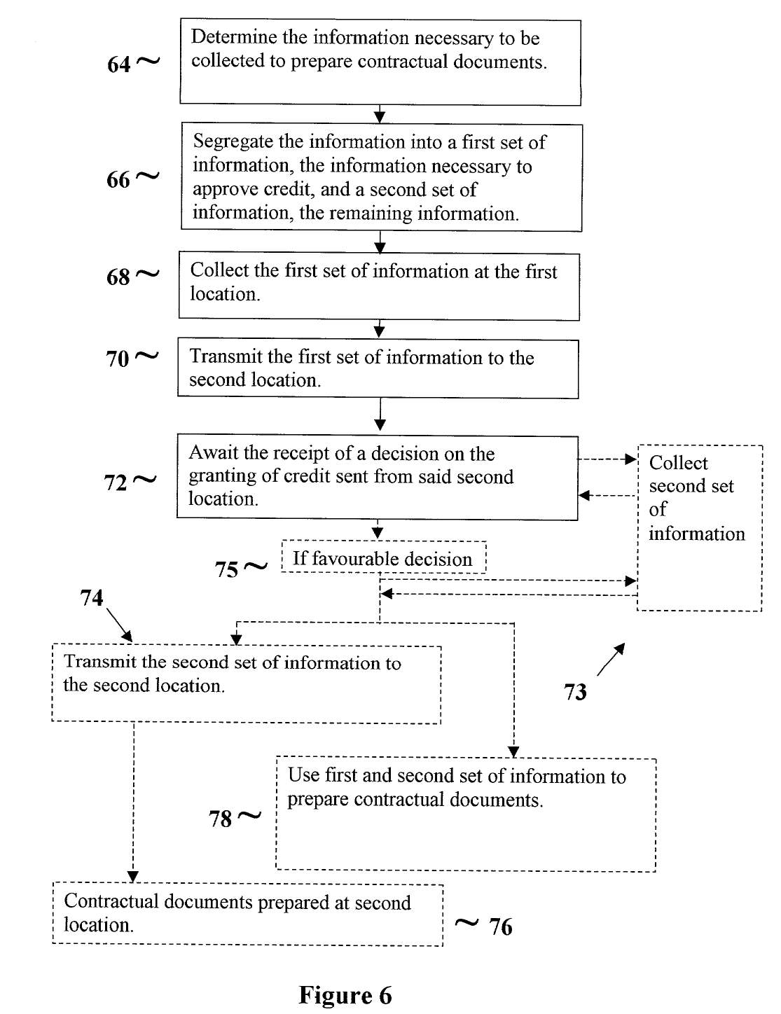

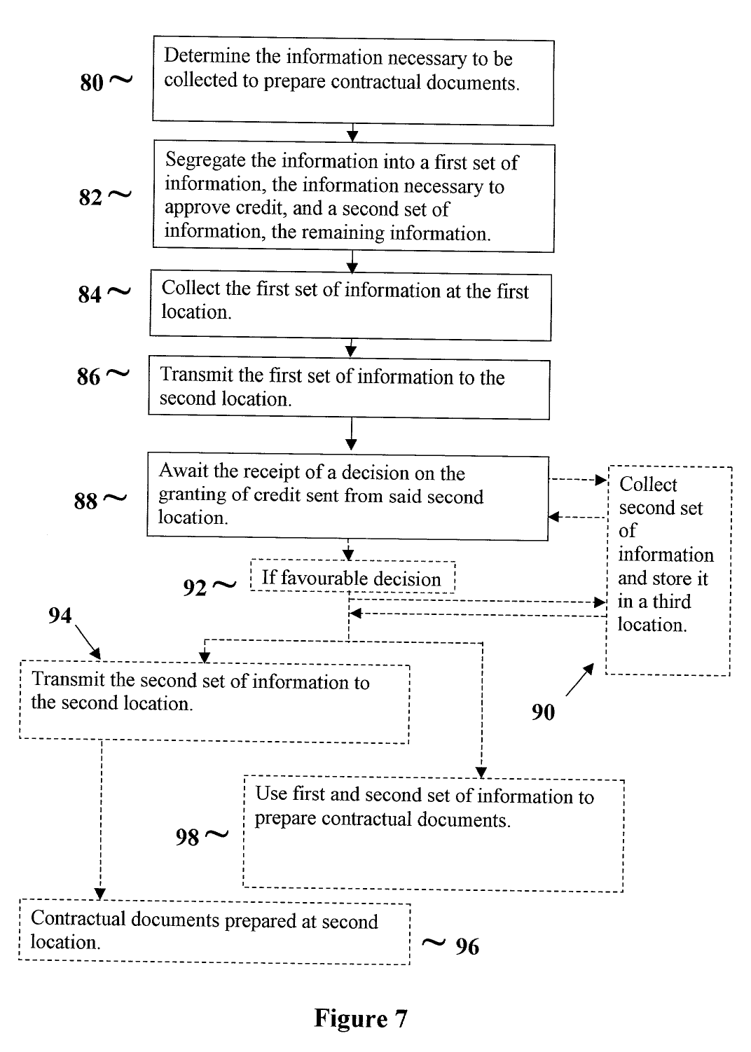

An alternative presentation of these methods is illustrated in FIGS. 6 and 7, where information is collected at one location and is transmitted to a second location for asset-secured credit approval. In FIG. 6, in step 64 the information necessary to be collected to prepare contractual documents (which necessarily includes the information necessary to approve the extension of credit) is determined. In step 66, the information is segregated into a first set of information, which is the information necessary to approve credit, and a second set of information, which is the remaining information from the information determined in step 64. In step 68, the first set of information is collected (usually from the potential customer) at the first location. In step 70, the first set of information is transmitted via wireless communication to the second location, and in step 72 the person in the first location awaits the receipt of a decision on the granting of credit to arrive from the second location.

The remaining steps of this method can take one of various paths (shown in dashed lines), depending on whether the contractual documents are to be prepared at the first location or the second location and when the second set of information is collected. The second set of information may be collected in step 73 either before the receipt of a credit granting decision, or it may be collected after the receipt of a favourable credit-granting decision in step 75.

If the contractual documents are to be prepared at the second location, then if a favourable credit-granting decision is received, in step 74 the second set of information is transmitted to the second location, and in step 76 the contractual documents are prepared at the second location. If the contractual documents are to be prepared at the first location, then if a favourable credit-granting decision is received, in step 78 the second set of information is used (along with the first set of information) to create contractual documents.

A second method is illustrated in FIG. 7. In FIG. 7, in step 80 the information necessary to be collected to prepare contractual documents (which necessarily includes the information necessary to approve the extension of credit) is determined. In step 82, the information is segregated into a first set of information, which is the information necessary to approve credit, and a second set of information, which is the remaining information from the information determined in step 80. In step 84, the first set of information is collected (usually from the potential customer) at the first location. In step 86, the first set of information is transmitted via wireless communication to the second location, and in step 88 the person in the first location awaits the receipt of a decision on the granting of credit to arrive from the second location.

The remaining steps of this method can take one of various paths (shown in dashed lines), depending on whether the contractual documents are to be prepared at the first location or the second location and when the second set of information is collected. The second set of information may be collected in step 90 either before the receipt of a credit granting decision, or it may be collected after the receipt of a favourable credit-granting decision in step 92. In step 90, the second set of information is stored at a third location.

If the contractual documents are to be prepared at the second location, then if a favourable credit-granting decision is received, in step 94 the second set of information is transmitted from the third location to the second location, and in step 96 the contractual documents are prepared at the second location. If the contractual documents are to be prepared at the first or third location, then if a favourable credit-granting decision is received, in step 98 the second set of information stored in the third location is used (along with the first set of information) to create contractual documents at either the first or third locations.

Those skilled in the art will appreciate that various modifications of detail may be made to the preferred embodiments described herein, which would come within the spirit and scope of the invention as described in the following claims.

1. A method for approving asset secured credit requests comprising the steps of:
(a) taking applicant identification information from an applicant in a first location;
(b) sending at least some of the applicant identification information to a decision maker in a second location; and
(c) receiving a decision from the decision maker; wherein the step of sending at least some of the applicant identification information to a decision maker in a second location comprises
(d) entering the at least some of the applicant identification information into a wireless communications device;
(e) transmitting the applicant identification information to the decision maker via a signal transmitted by the wireless communication device; and wherein the step of receiving a decision from the decision maker further comprises:
(f) receiving a decision from the decision maker via a signal received by the wireless communications device.

2. The method of claim 1 wherein said step of transmitting the applicant identification information comprises transmitting only the applicant identification information.

3. The method of claim 2 wherein the applicant identification information is the minimum data required to identify a potential borrower.

4. The method of claim 2 further comprising a step of preparing contractual documents using more information than the information transmitted to the decision maker to prepare the contractual documents.

5. The method of claim 4 wherein the step of preparing contractual documents using more information than the information transmitted to the decision maker to prepare the contractual documents comprises the steps of:
taking asset information from the applicant;
taking payment and banking information from the applicant;
entering the asset information and the payment and banking information into the wireless communications device; and
printing the contractual documents using the wireless communications device at the first location.

6. The method of claim 4 wherein the step of preparing contractual documents is performed by the decision maker.

7. The method of claim 2 wherein transmitting involves at least in part transmission over a packetized data network.

8. The method of claim 2 wherein the wireless communication device is a portable wireless communication device.

9. The method of claim 2 wherein the wireless communications device is a hand-held computing device.

10. The method of claim 1 wherein the decision maker is an automated decision maker.

11. A method for approving asset secured credit requests comprising the steps of
(a) taking applicant identification and asset information from an applicant for credit in a first location;
(b) sending at least some of the applicant identification information and at least some of the asset information to a decision maker in a second location; and
(c) receiving a decision from a decision maker;
wherein the step of sending at least some of the applicant identification information to a decision maker in a second location comprises:
(d) entering the at least some of the applicant identification information and the at least some of the asset information into a wireless communications device;
(e) transmitting the at least some of the applicant identification information and the at least some of the asset information to the decision maker via a signal transmitted by the wireless communication device; wherein the step of receiving a decision from the decision maker further comprises:
(f) receiving a decision from the decision maker via a signal received by the wireless communications device.

12. The method of claim 11 wherein the applicant identification information is the minimum data required to identify a potential borrower.

13. The method of claim 12 further comprising a step of preparing contractual documents using more information than the information transmitted to the decision maker to prepare the contractual documents.

14. The method of claim 13 wherein the step of preparing contractual documents using more information than the information transmitted to the decision maker to prepare the contractual documents comprises the steps of:
taking payment and banking information at the first location;
entering the payment and banking information into the wireless communications device, and
printing contractual documents using the wireless communications device at the first location.

15. The method of claim 13 wherein the step of preparing contractual documents using more information than the information transmitted to the decision maker to prepare the contractual documents is performed by the decision maker.

16. The method of claim 12 wherein transmitting involves at least in part transmission over a packetized data network.

17. The method of claim 12 wherein the wireless communication device is a portable wireless communication device.

18. The method of claim 12 wherein the wireless communications device is a hand-held computing device.

19. The method of claim 11 wherein the decision maker is an automated decision maker.

20. A method for approving asset secured credit requests over a wireless communication device, comprising the steps of:
(a) entering applicant identification information into the wireless communications device;
(b) transmitting only the applicant identification information to a decision maker via a signal transmitted by the wireless communication device; and
(c) receiving a decision on how much credit to offer from the decision maker.

21. The method of claim 20 further comprising the step of:
(d) preparing contractual documents using more information than the information transmitted to the decision maker to prepare the contractual documents.

22. The method of claim 20 wherein the applicant identification information is the minimum data required to identify a potential borrower.

23. The method of claim 22 further comprising the step of:
(d) preparing contractual documents using more information than the information transmitted to the decision maker to prepare the contractual documents.

24. The method of claim 21 wherein the step of preparing contractual documents using more information than the information transmitted to the decision maker to prepare the contractual documents comprises the steps of
taking asset information from the applicant;
taking payment and banking information from the applicant;
entering the asset information and the payment and banking information into the wireless communications device; and
printing the contractual documents using the wireless communications device at the first location.

25. The method of claim 21 wherein transmitting involves at least in part transmission over a packetized data network.

26. The method if claim 21 wherein the wireless communication device is a portable wireless communication device.

27. The method of claim 21 wherein the wireless communications device is a hand-held computing device.

28. The method of claim 21 wherein the step of preparing contractual documents is performed by the decision maker.

29. The method of claim 21 wherein the decision maker is an automated decision maker.

30. A method for approving asset secured credit requests over a wireless communication device, comprising the steps of:
(a) entering applicant identification information and asset information into the wireless communications device;
(b) transmitting the applicant identification information and asset information to a decision maker via a signal; and
(c) receiving a decision on how much credit to offer from the decision maker.

31. The method of claim 30 wherein the applicant identification information is the minimum data required to identify a potential borrower.

32. The method of claim 31 further comprising:
(d) preparing contractual documents in accordance with such decision, while using more information than the information which had been transmitted to the decision maker.

33. The method of claim 32 wherein the step of preparing contractual documents comprises the steps of:
taking payment and banking information,
entering the payment and banking information into the wireless communications device; and
printing contractual documents using the wireless communications device.

34. The method of claim 31 wherein transmitting involves at least in part transmission over a packetized data network.

35. The method of claim 31 wherein the wireless communication device is a portable wireless communication device.

36. The method of claim 31 wherein the wireless communications device is a hand-held computing device.

37. The method of claim 31 wherein the decision maker is an automated decision maker.

38. The method of claim 32 wherein the step of preparing contractual documents is performed by the decision maker.

39. In a method for securing approval of an asset-secured credit transaction, in which information is collected at a first location and is submitted to a second location for transaction approval and preparation of contract documentation, the improvement which comprises:
(a) determining the information necessary to be collected for transmission to the second location;
(b) segregating such information into a first set of information and a second set of information, said first set comprising information necessary for credit approval and said second set comprising the remaining information;
(c) collecting at least the first set of information at said first location;
(d) transmitting said first set of information to the second location via wireless communication;
(e) awaiting the receipt of a decision on the granting of credit sent from said second location; and
(f) if a decision favourable to the granting of credit is received from said second location, then transmitting the second set of information to said second location.

40. The method of claim 39 in which at least a portion of said second set of information is not collected unless and until a decision favourable to the granting of credit is received.

41. The method of claim 39, in which the second set of information is removed from the first location to a third location in a stored form prior to transmission, and is transmitted to the second location from the third location.

42. The method of claim 40, in which the second set of information is removed from the first location to a third location in a stored form prior to transmission, and is transmitted to the second location from the third location.

43. The method of claim 40, wherein the wireless communication is performed with a portable wireless communications device.

44. The method of claim 40, wherein transmitting involves at least in part transmission over a packetized data network.

45. In a method for securing approval of an asset-secured credit transaction, in which information is collected at a first location and is submitted to a second location for transaction approval, the improvement which comprises:
(a) determining the information necessary to be collected for the preparation of contractual documents;
(b) segregating such information into a first set of information and a second set of information, said first set comprising information necessary for credit approval and said second set comprising the remaining information;
(c) collecting at least the first set of information at said first location;
(d) transmitting said first set of information to the second location via wireless communication; and
(e) awaiting the receipt of a decision on the granting of credit sent from said second location.

46. The method of claim 45, further comprising:
(f) if a decision favourable to the granting of credit is received from said second location, then using the first set of information and the second set of information to prepare contractual documents.

47. The method of claim 46, in which the second set of information is removed from the first location to a third location in a stored form prior to preparation of the contractual documents.

48. The method of claim 45 in which at least a portion of said second set of information is not collected unless and until a decision favourable to the granting of credit is received.

49. The method of claim 48, further comprising:
(f) if a decision favourable to the granting of credit is received from said second location, then using the first set of information and the second set of information to prepare contractual documents.

50. The method of claim 49, in which the second set of information is removed from the first location to a third location in a stored form prior to preparation of the contractual documents.

51. The method of claim 45, wherein the wireless communication is performed with a portable wireless communications device.

52. The method of claim 45, wherein transmitting involves at least in part transmission over a packetized data network.
